(19) United States
(12) Patent Application Publication
(10) Pub. No.: US 2008/0254648 A1
(43) Pub. Date: Oct. 16, 2008

(54) System for Detachably Connecting a Large Number of Signal Lines of Two Components

(75) Inventor: Raymond Wilhelmus Louis Lafarre, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,595

(22) PCT Filed: Jan. 24, 2005
(86) PCT No.: PCT/IB2005/050272

§ 371 Date: Aug. 1, 2006

(30) Foreign Application Priority Data
Feb. 5, 2004 (EP) 04100424.3

(51) Int. Cl. H01R 12/12; H01R 43/00

(52) U.S. Cl. 439/55; 29/884

(57) ABSTRACT

A system for detachably connecting a first electronic component with a second electronic component (6), whereby a large number of signal lines of the first component are connected with corresponding signal lines of the second component (6). A sheet-like part (2) of the first component is provided with a number of conducting areas (4) arranged in an array at the surface of the sheet-like part (2) near an edge (3) of said sheet-like part (2). Each of said conducting areas (4) is connected with a signal line of the first component. A part of the second component (6) is provided with a number of contact elements (7) arranged in an array at the surface of said part, whereby each of said contact elements (7) is connected with a signal line of the second component (6). Each contact element (7) has a contact surface for contacting one of said conducting areas (4) of the first component. Means (10) are present to push each of said conducting areas (4) of the first component against a corresponding contact element (7) of the second component (6).

The invention is related to a system for detachably connecting a first electronic component with a second electronic component, whereby a large number of signal lines of the first component are connected with corresponding signal lines of the second component.

The first component is for example a display provided with a screen having a large number of pixels, whereby each pixel can change its appearance dependent on an electrical signal supplied by electrical signal lines in the material of the display, so that a certain image will appear on the screen. In case the electrical signals for producing the image on the screen are supplied to the display through or by a second component, each signal line of the first component (the display) has to be connected with a corresponding signal line of the second component, and, for several reasons, it may be required that the connection is detachable.

Such connection can be established by means of electric plugs, each comprising a large number of contact elements, whereby one part of the plug is attached to the first component and the complementary part of the plug is attached to the second component. However, plugs with large numbers of electrical contacts are voluminous and difficult to handle by not skilled users. Furthermore, when making use of electric plugs, both components have to be provided with a rather voluminous part of the plug, and it may be desired that at least one of the mutual connectable and detachable components is small and/or inexpensive, for example when such component has a short life time and/or should be changed from time to time. In case the other component is reused several times, such component may have a more complicated and/or expensive connecting part.

Another way of establishing such a connection is through clamping a flexfoil into a connector, as is done routinely inside small electronic devices such as diskmans and mobile phones. However, due to the nature of the connection only up to ten lines can be connected at a time, and only by a skilled person, not by the user of the device. Furthermore, these connections are only intended to be made once, upon assembly of the device.

The object of the invention is a system for detachably connecting a first electronic component with a second electronic component, whereby a reliable electric connection between a large number of signal lines of each of the components is required, and whereby at least one of the components is free from complicated or relative large connection devices.

To accomplish with that object, a sheet-like part of the first component is provided with a number of conducting areas arranged in an array at the surface of the sheet-like part near an edge of said sheet-like part; whereby each of said conducting areas is connected with a signal line of the first component, and whereby a part of the second component is provided with a number of contact elements arranged in an array at the surface of said part, whereby each of said contact elements is connected with a signal line of the second component, whereby each contact element has a contact surface for contacting one of said conducting areas of the first component, and whereby means are present to push each of said conducting areas of the first component against a corresponding contact element of the second component.

So, the signal lines of the first component terminate in conducting areas at the surface of the sheet-like part of the first component at a location where such conducting areas can contact the contact surfaces of the corresponding contact elements of the second component. When the first component is attached to the second component, each signal line of the first component is electrically connected to the corresponding contact element of the second component. There may be more contact elements at the second component than conducting areas at the first component, because another first component, which can be connected to the same second component, may have more conducting areas.

In general, the signal lines of the components have relative small transverse dimensions and are positioned close to each other, so that a large number of signal lines can be accommodated on a relative small area of the material of the component. However, the conducting areas should have a much larger dimension to make sure that the contact with the corresponding contact element can be reliably established. Therefore, in one preferred embodiment, the conducting areas are distributed in a two dimensional pattern on the sheet-like part of the first component, preferably the conducting areas are arranged in two or more parallel arrays, in stead of one array. Such arrays may have equal lengths, but also may have different lengths and/or a different number of conducting areas. By arranging the conducting areas in two or more, preferably in three or more, more preferably in four or more mutually parallel arrays, a large number of relative large conducting areas can be accommodated on a limited area of the surface of the sheet-like part of the first component.

The expression array is used for a row of conducting areas. The row may be substantial straight or more or less curved. The conducting areas may have equal distances relative to each other or varying distances. Therefore, the conducting areas may be distributed over a certain region of the first component. Preferably, the first component is provided with more than 200 conducting areas, preferably more than 500 conducting areas. For example, such number of signal lines can produce a rather detailed image on the screen of a display.

In one preferred embodiment, the contact surface of the contact element is at least four times, preferably eight times, and more preferably sixteen times smaller than the corresponding conducting area. Furthermore, the contact surfaces of the contact elements may protrude, preferable more then 0.01 mm, with respect to the remainder of the surface of the second component near the contact elements. The relative small and preferably protruding contact surfaces of the contact elements of the second component increases the reliability of the electric contact and prevents the contact elements from contacting the material of the sheet-like part of the first component outside the conducting areas, even in case of small variations in the dimensions of the arrays of conducting areas. Therefore, the space between conducting areas can be provided with signal lines that are connected to other conducting areas, which signal lines may be present at the surface of the sheet-like part of the first component.

In one preferred embodiment, the sheet-like part of the first component and/or the said part of the second component is made of flexible material. For example, in case the first component is a flexible display, i.e. a display consisting of thin flexible material, the sheet-like part can also be made of the same flexible material. The relative large surface of each conducting area provides for a more reliable electric contact, in particular when the material carrying the conducting areas is flexible, whereby the distances between the conducting areas can vary a little.

The conducting areas of the first component have to be pushed against the contact surfaces of the contact elements of the second component to ensure the presents of electric contact. Different kinds of clamping means can be used to generate the required pushing force. In one preferred embodiment, a number of spring members are present, whereby each spring member pushes more than one, preferably more than six contact elements and the corresponding conducting areas against each other, when the first component is connected to the second component.

The spring members can be part of a separate clamping member, for example provided with a slot in which the sheet-like part of the first component as well as a sheet-like part of the second component comprising the contact elements can be inserted in order to be pushed against each other. However, in one preferred embodiment, the spring members are attached to the second component.

Preferably, neighbouring conducting areas in different arrays are pushed by the same spring member against the corresponding contact elements of the second component. When more contact elements of the second component are pushed against corresponding conducting areas of the first component by the same spring member, the pushing force of the spring member has to be distributed equally over the different contact elements. The flexibility of the material of the sheet-like part of the first component and/or the flexibility of the material of the second component and/or the elasticity of the spring member may provide for the required distribution of the pushing force.

So, preferably, a group of neighbouring conducting areas are pushed against corresponding contact elements by one spring member. In one preferred embodiment, the conducting areas are located on substantial straight lines perpendicular with respect to the direction of the arrays, whereby a spring member pushes all conducting areas located on two neighbouring lines against corresponding contact elements, which contact elements are also located on two neighbouring lines perpendicular to the arrays. Thereby, a spring member pushes two successive conducting areas of each array against corresponding contact elements. In case six arrays of conducting areas are present, then each spring member pushes twelve conducting areas against twelve corresponding contact elements.

In one preferred embodiment, the sheet-like part of the first component, provided with the conducting areas at its surface, is located between said spring members and said contact elements of the second component, so that the spring member pushes against the back side of the sheet-like part of the first component, while the conducting areas are present at the front side of that part.

Preferably, the spring member is a leaf spring having a flat part for abutting against the sheet-like part of the first component over an area of the sheet-like part comprising two or more conducting areas, so that the two or more conducting areas are pushed against corresponding contact elements.

In one preferred embodiment, one end of said flat part of the leaf spring is connected to a substantial parallel part of the leaf spring through a curved part of the leaf spring making a curve of about 180°, whereby the end of said parallel part is attached to a part of the second component or to a clamping member that can be attached to the second component. And preferably, the other end of said flat part of the leaf spring is connected to the end part of the leaf spring through a curved part of the leaf spring making a curve of about 135° in the other direction, whereby means are present that can push against said end part in order to displace said flat part of the leaf spring away from the contact elements.

Preferably, the leaf springs are positioned in a row parallel to each other, whereby successive leaf springs pushes two successive conducting areas in each array against corresponding contact elements, which conducting areas are positioned on two lines perpendicular to the direction of the arrays. Thereby the leaf springs can be fixed to a bar extending parallel to the arrays of conducting areas. The configuration of the leaf springs will be further elucidated when an embodiment of the system is described.

The invention is also related to a clamping member for a for detachably connecting a first electronic component with a second electronic component, whereby a large number of signal lines of the first component are connected with corresponding signal lines of the second component, whereby a sheet-like part of the first component is provided with a number of conducting areas arranged in one or more arrays at the surface of the sheet-like part near an edge of said sheet-like part, whereby each of said conducting areas is connected with a signal line of the first component, and whereby a part of the second component is provided with a number of contact elements arranged in one or more arrays at the surface of said part, whereby each of said contact elements is connected with a signal line of the second component, whereby each contact element has a contact surface for contacting one of said conducting areas of the first component, which clamping member comprises a row of leaf springs, whereby each leaf spring can push more than one conducting area of the first component against corresponding contact elements of the second component.

The invention of furthermore related to a method for detachably connecting a first electronic component with a second electronic component, whereby a large number of signal lines of the first component are connected with corresponding signal lines of the second component, whereby a sheet-like part of the first component is provided with a number of conducting areas arranged in one or more arrays at the surface of the sheet-like part near an edge of said sheet-like part, whereby each of said conducting areas is connected with a signal line of the first component, and whereby a part of the second component is provided with a number of contact elements arranged in one or more arrays at the surface of said part, whereby each of said contact elements is connected with a signal line of the second component, whereby each contact element has a contact surface for contacting one of said conducting areas of the first component, and whereby each of said conducting areas of the first component is pushed against a corresponding contact element of the second component.

The invention will now be explained by means of a description of an embodiment of a system for detachably connecting a first component, being a flexible display, to a second component, being a connection member, in which reference is made to the drawing, in which:

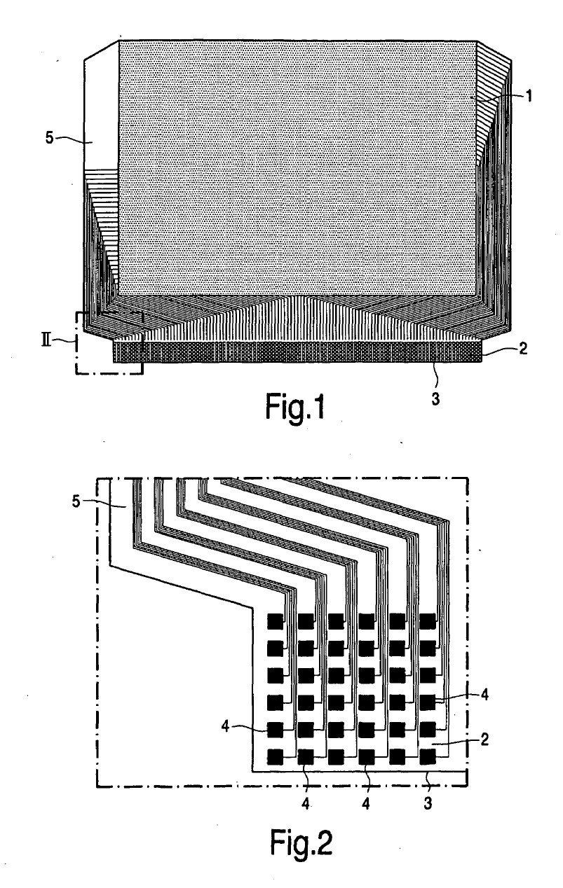

FIG. 1 shows a detachable flexible display;

FIG. 2 shows a part of FIG. 1 in more detail;

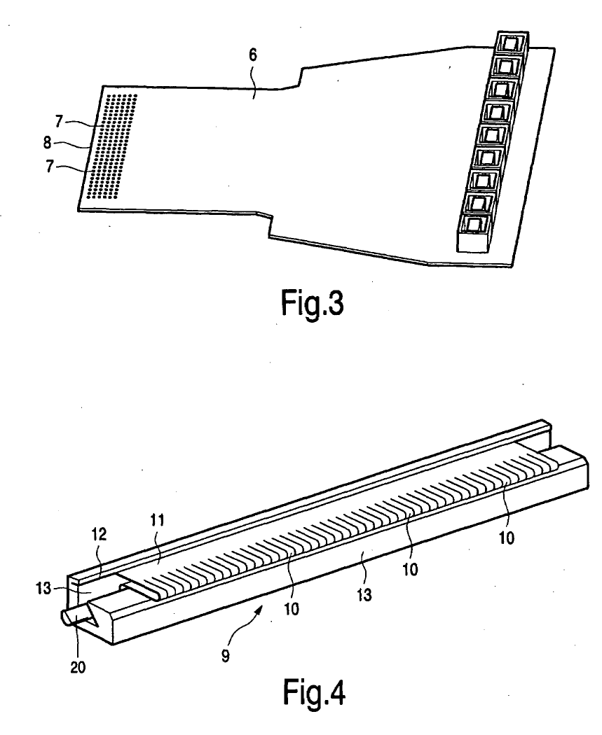

FIG. 3 is a perspective view of a connection member;

FIG. 4 is a perspective view of a clamping member; and

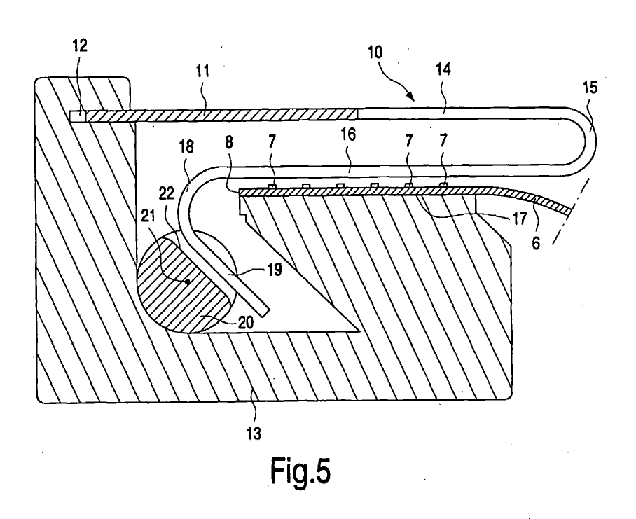

FIG. 5 is a sectional view of the clamping member.

The figures are schematic representations, whereby only relevant portions of the system are shown.

FIG. 1 is a front view of a detachable flexible display. The display consists of a thin sheet of flexible multilayer material. A rectangular part of the sheet of material is a screen 1, provided with a large number of pixels arranged in arrays (parallel to the long side of the rectangle) and columns (parallel to the short side of the rectangle). Each pixel can appear or disappear on the screen, dependent on an electric potential in signal lines extending near the pixel. There are signal lines parallel to the long side of the rectangular screen 1 and signal lines parallel to the short side of the rectangular screen 1, which both groups of signal lines are present in different layers of the multilayer sheet material of the display. A crossing of two signal lines is present at the location of each pixel, and the pixel will appear on the screen in case a certain electric potential is present in both of those two signal lines. Therefore, by controlling the electric potential in each of the signal lines, an image can be generated on the screen 1.

Furthermore, the display is provided with an elongated rectangular part 2 at the lower side near edge 3 of the display in FIG. 1. The surface of rectangular part 2 is provided with a large number of square conducting areas 4, arranged in six arrays parallel to the edge 3 of the display. FIG. 2 shows a part of the display at an enlarged scale, as indicated in FIG. 1 with the rectangle 11. In FIG. 2 more details are visible, in particular the six arrays of square conducting areas 4. Of course, the conducting areas may have another shape than a square shape. Each conducting area 4 is connected to a signal line. Thereby, signal lines of conducting areas near the edge 3 are present between the conducting areas 4 further away from the edge 3.

The signal lines run from each conducting area 4 to the sides of the rectangular screen 1 and then they form the said signal lines in the material of the screen 3 parallel to the long side and parallel to the short side of the screen respectively. From the conducting area 4 to the screen 1 the signal lines are imbedded in the material 5 of the display around the screen 3.

To generate an image on the screen 1 of the display, the conducting areas 4 on the elongated rectangular part 2 of the display has to be detachably connected to driver electronics on another component, hereinafter called connection member. Thereby each conducting area 4 must be connected to a corresponding signal line of the connection member.

FIG. 3 shows a connection member 6, which can be provided with electronic components (not shown) such as driving electronics to generate signals to be supplied to the display of FIG. 1. Connection member 6 is provided with a large number of signal lines, each terminating in a contact element 7 near the edge 8 of the connection member 6. The contact elements 7 are arranged in six arrays having the same dimensions as the six arrays of conducting areas 4 on the display of FIG. 1. Each contact element 7 protrudes out of the material of the connection member 6, in order to have a protruding contact surface for contacting the corresponding conducting area 4 of the display.

To connect each contact element 7 with a corresponding conducting area 4, the elongated rectangular sheet-like part 2 near the edge 3 of the display can be positioned on the surface near the edge 8 of connection member 6, so that each contact element 7 of the connection member 6 corresponds with a conducting area 4 of on display. Because the surfaces of the conducting areas 4 are much larger than the contact surfaces of the contact elements 7, there will also be a correct positioning of the contact elements 7 with respect to the corresponding conducting areas 4 when the mutual positions of the conducting areas 4 varies a little, for example because of the flexibility of the material of the display. And thereby it is ensured that the contact elements 7 will not tough the signal lines that may be present between the conducting areas 4.

A variation of the mutual distances of the conducting areas 4 may also be created during the manufacturing of the display, whereby the material is subjected to high temperatures. Furthermore, the dimensions of the conductive areas 4 may vary, so that a larger conductive area 4 is present at locations where the accuracy of the dimensions is less, for example further away from a reference point, where the positioning of the part 2 of the first component and the relevant part of the second component is exact.

To achieve a reliable electric connection between each contact element 7 with the corresponding conducting area 4, a pushing force has to press part 2 of the display and the corresponding part of the connection member 6 together.

FIG. 4 shows a clamping member 9 that can press part 2 of the display and the part of the connection member 6 near edge 8 together, in order to electrically connect conducting areas 4 with corresponding contact elements 7. Clamping member 9 comprises a number of leaf springs 10 positioned in a row parallel to each other. FIG. 5 is a sectional view of clamping member 9 between two neighbouring leaf springs 10.

All leaf springs 10 have a common base 11. The leaf springs 10 and their common base 11 are manufactures out of a rectangular metal plate. Thereby the leaf springs 10 are formed by making parallel straight slots in the rectangular metal plate extending parallel to the short sides of the rectangle. The slots extend from a long side to a location at some distance from the other long side, so that along said other long side the said common base 11 is created. As a result, a number of parallel straight bars extend from the common base 11, and by bending these bars the desired row of parallel leaf springs 10, as shown in FIGS. 4 and 5, is shaped.

As shown in FIG. 5, the common base 11 of the leaf springs 10 is fixed in a slot 12 of the main body 13 of the clamping member 9. The first part 14 of the parallel leaf springs 10 extend from the other side of the common base 11 in the plane of the common base 11. The second part 15 of the leaf spring 10 is a curved part making a curve over 180°. The third part 16 of the leaf spring 10 is a flat part, which flat part 16 extends substantial parallel to a flat surface 17 of the main body 13 of the clamping member 9. The fourth part 18 of the leaf spring 10 is a curved part making a curve over about 135° in the other direction compared to the other curved part 15. The fifth part 19 is again a flat part of the leaf spring 10.

In the embodiment as shown in FIG. 5, the part of the connection member 6 near edge 8 is fixed on the flat surface 17 of the main body 13 of the clamping member 9, for example by means of an appropriate glue. Thereby the contact elements 7 protrude in upward direction from the surface of the material of connection member 6. There are six arrays of contact elements 7, which arrays extend perpendicular to the direction of the leaf springs 10. The width of the leaf springs 10 is more than the distance between two neighbouring contact elements 7 in the arrays, so that the flat part 16 of each leaf spring 10 covers two neighbouring contact elements 7 of each array, and in total twelve contact elements 7 are covered by each flat part 16.

In order to electrically connect the contact elements 7 with corresponding conducting areas 4, the elongated rectangular sheet-like part 2 near the edge 3 of the display is positioned between the flat parts 16 of the leaf springs 10 and the part of connection member 6 that is fixed to surface 17. In that position, the flat parts 16 will push the conducting areas 4 against the corresponding contact elements 7. Because of the shape of the leaf spring 10, the flat part 16 can move in substantial vertical direction (in FIG. 5), so that the spring force of the leaf spring 10 pushes flat part 16 downward in vertical direction. Thereby the conducting areas 4 in different arrays will be pushed with substantial equal forces downwardly.

In order to release the rectangular part 2 of the display, the flat part 16 of the leaf spring can be lifted by rotating operation member 20 around its axis 21. Operation member 20 is shown in FIG. 5 in cross section. Member 20 has a flat surface 22, so that the edge of that flat surface 22 will abut part 19 of the leaf spring 10 when member 20 is rotated counterclockwise. It will be clear that the flat part 16 of the leaf spring 10 is lifted when the operation member 20 is further rotated. Because of the shape of leaf spring 10, the flat part 16 is lifted over its entire length.

When the flat parts 16 of leaf springs 10 are lifted, the rectangular part 2 of the display can be inserted or removed between the flat part 16 and the part of the connection member 6 that is fixed on the flat part 17 of the main body 13. Certain reference surfaces of the clamping member 9, which are not shown on the figures, are present to keep the rectangular part 2 in a correct position when the flat parts 16 of the leaf springs 10 is brought in its pushing condition.

The leaf springs 10 can be made of any elastic material, for example metal or plastic material. The other parts of the clamping member 9 can also be made of any appropriate material, for example also metal or plastic material.

FIG. 4 shows the clamping member 9 without the parts of the electronic components to be pushed together. Both parts can be brought together between the flat parts 16 of the leaf springs 10 and the flat surface 17. However, preferably the relevant part of the connection member 6 is fixed to the flat surface as shown in FIG. 5.

The embodiment as described above is merely an example of a system for detachably connecting a first electronic component with a second electronic component; a great many other embodiments are possible.

1. A system for detachably connecting a first electronic component with a second electronic component (6), whereby a large number of signal lines of the first component are connected with corresponding signal lines of the second component (6), whereby a sheet-like part (2) of the first component is provided with a number of conducting areas (4) arranged in an array at the surface of the sheet-like part (2) near an edge (3) of said sheet-like part (2), whereby each of said conducting areas (4) is connected with a signal line of the first component, and whereby a part of the second component (6) is provided with a number of contact elements (7) arranged in an array at the surface of said part, whereby each of said contact elements (7) is connected with a signal line of the second component (6), whereby each contact element (7) has a contact surface for contacting one of said conducting areas (4) of the first component, and whereby means (10) are present to push each of said conducting areas (4) of the first component against a corresponding contact element (7) of the second component (6).

2. A system as claimed in claim 1, characterized in that the conducting areas (4) are distributed in a two dimensional pattern on the sheet-like part (2) of the first component, preferably the conducting areas (4) are arranged in two or more parallel arrays.

3. A system as claimed in claim 1, characterized in that the first component is provided with more than 200 conducting areas (4), preferably more than 500 conducting areas (4).

4. A system as claimed in claim 1, characterized in that said contact surface of the contact element (7) of the second component (6) is at least four times, preferably eight times, and more preferably sixteen times smaller than said conducting area (4) of the first component.

5. A system as claimed in claim 1, characterized in that the sheet-like part (2) of the first component and/or the said part of the second component (6) is made of flexible material.

6. A system as claimed in claim 1, characterized by a number of spring members (10), whereby each spring member (10) pushes more than one, preferably more than six contact elements (7) and the corresponding conducting areas (4) against each other, when the first component is connected to the second component (6).

7. A system as claimed in claim 6, characterized in that the spring members (10) are attached to the second component (6).

8. A system as claimed in claim 6, characterized in that neighbouring conducting areas (4) in different arrays are pushed by the same spring member (10) against the corresponding contact elements (7).

9. A system as claimed in claim 6, characterized in that the conducting areas (4) are located on substantial straight lines perpendicular with respect to the direction of the arrays, whereby a spring member (10) pushes all conducting areas (4) located on two neighbouring lines against the corresponding contact elements (7).

10. A system as claimed in claim 6, characterized in that the sheet-like part (2) of the first component, provided with the conducting areas (4) at its surface, is located between said spring members (10) and said contact elements (7) of the second component (6).

11. A system as claimed in claim 6, characterized in that said spring member is a leaf spring (10) having a flat part (16) for abutting against the sheet-like part (2) of the first component over an area of the sheet-like part (2) comprising two or more conducting areas (4), so that the two or more conducting areas (4) are pushed against the corresponding contact elements (7).

12. A system as claimed in claim 11, characterized in that one end of said flat part (16) of the leaf spring (10) is connected to a substantial parallel part (14) of the leaf spring (10) through a curved part (15) of the leaf spring (10) making a curve of about 180°, whereby the end of said parallel part is attached to a part (11) of the second component (6).

13. A system as claimed in claim 12, characterized in that the other end of said flat part (16) of the leaf spring (10) is connected to the end part (19) of the leaf spring (10) through a curved part (18) of the leaf spring (10) making a curve of about 135° in the other direction, whereby means (20) are present that can push against said end part (19) in order to displace said flat part (16) of the leaf spring (10) away from the contact elements (7).

14. A system as claimed in claim 11, characterized in that the leaf springs (10) are positioned in a row parallel to each other, whereby successive leaf springs (10) pushes two, or more, successive conducting areas (4) in each array to corresponding contact elements (7), which conducting areas (4) are positioned on two, or more, lines perpendicular to the direction of the arrays.

15. A clamping member for a for detachably connecting a first electronic component with a second electronic component (6), whereby a large number of signal lines of the first component are connected with corresponding signal lines of the second component, whereby a sheet-like part (2) of the first component is provided with a number of conducting areas (4) arranged in one or more arrays at the surface of the sheet-like part (2) near an edge (3) of said sheet-like part (2), whereby each of said conducting areas (4) is connected with a signal line of the first component, and whereby a part of the second component (6) is provided with a number of contact elements (7) arranged in one or more arrays at the surface of said part, whereby each of said contact elements (7) is connected with a signal line of the second component, whereby each contact element (7) has a contact surface for contacting one of said conducting areas (4) of the first component, which clamping member (9) comprises a row of leaf springs (10), whereby each leaf spring (10) can push more than one conducting area (4) of the first component against corresponding contact elements (7) of the second component (6).

16. A method for detachably connecting a first electronic component with a second electronic component (6), whereby a large number of signal lines of the first component are connected with corresponding signal lines of the second component (6), whereby a sheet-like part (2) of the first component is provided with a number of conducting areas (4) arranged in one or more arrays at the surface of the sheet-like part (2) near an edge (3) of said sheet-like part (2), whereby each of said conducting areas (4) is connected with a signal line of the first component, and whereby a part of the second component (6) is provided with a number of contact elements (7) arranged in one or more arrays at the surface of said part, whereby each of said contact elements (7) is connected with a signal line of the second component (6), whereby each contact element (7) has a contact surface for contacting one of said conducting areas (4) of the first component, and whereby each of said conducting areas (4) of the first component is pushed against a corresponding contact element (7) of the second component (6).
